(19) United States
(12) Patent Application Publication
(10) Pub. No.: US 2008/0301954 A1
(43) Pub. Date: Dec. 11, 2008

(54) AIR POWERED ROOFING SAW WITH GEAR DRIVE

(76) Inventor: Robert Garrett, Severn, MD (US)

Correspondence Address: Robert Platt Bell;Registered Patent Attorney, P.O. Box 13165, Jekyll Island, GA, 31527, US

(21) Appl. No.: 11/947,027

(22) Filed: Nov. 29, 2007

Related U.S. Application Data
(63) Continuation-in-part of application No. 10/691,967, filed on Oct. 24, 2003, now abandoned.
Application No. 10/691,967 is a continuation-in-part of application No. 10/388,642, filed on Mar. 17, 2003, now Pat. No. 6,926,241.
Application No. 10/388,642 is a continuation-in-part of application No. 10/050,964, filed on Jan. 22, 2002, now Pat. No. 6,745,869.
(60) Provisional application No. 60/365,538, filed on Mar. 20, 2002.
(60) Provisional application No. 60/426,808, filed on Nov. 18, 2002.
(60) Provisional application No. 60/262,650, filed on Jan. 22, 2001.
(60) Provisional application No. 60/286,527, filed on Apr. 27, 2001.
(60) Provisional application No. 60/297,530, filed on Jun. 13, 2001.
(60) Provisional application No. 60/304,098, filed on Jul. 11, 2001.

(51) Int. Cl. B27B 9/02; B23D 47/10

(52) U.S. Cl. 30/391; 30/505; 30/517; 30/276; 30/277.4

(57) ABSTRACT

SHINGLESAW™ is a pneumatically powered miniaturized circular saw designed especially for roofing applications. A planetary gear set is provided to reduce the RPMs of the saw an increase torque, allowing the saw to cut though heavy and sticky roofing materials even when used with a low CFM roofer's compressor.

### CROSS-REFERENCE TO RELATED APPLICATIONS

The present application is a Continuation-In-Part of U.S. patent application Ser. No. 10/691,967 filed on Oct. 24, 2003, and incorporated herein by reference; The present application is a Continuation-in-Part of U.S. patent application Ser. No. 10/388,642, filed on Mar. 17, 2003, and incorporated herein by reference, which in turn claims priority from Provisional U.S. Patent Application No. 60/365,538, filed on Mar. 20, 2002, and incorporated herein by reference; parent application Ser. No. 10/388,642, filed Mar. 17, 2003 also claims priority from Provisional U.S. Patent Application No. 60/426,808, filed on Nov. 18, 2002, and incorporated herein by reference; parent application Ser. No. 10/388,642, filed Mar. 17, 2003 is also a Continuation-In-Part of U.S. patent application Ser. No. 10/050,964, filed on Jan. 22, 2002, and incorporated herein by reference; that application claims priority from the following Provisional Patent Applications, all of which are incorporated herein by reference: Provisional U.S. Patent Application No. 60/262,650, filed on Jan. 22, 2001; Provisional U.S. Patent Application No. 60/286,527, filed on Apr. 27, 2001; Provisional U.S. Patent Application No. 60/297,530, filed on Jun. 13, 2001; and Provisional U.S. Patent Application No. 60/304,098, filed on Jul. 11, 2001.

### FIELD OF THE INVENTION

The present invention relates to the field of residential and commercial roofing. In particular, the present application is also directed toward an air-powered saw with a gear reduction drive for use in cutting shingles for ridgelines and the like.

### BACKGROUND OF THE INVENTION

When installing roofing materials, it is often necessary to cut shingles either before installation, or in situ. For example, when building a roof “Valley”, shingles may be installed over the valley, and then later cut to the valley “V” shape. In addition, when finishing a roof, it is often necessary to cut the shingles along the edge of the roof to provide a uniform appearing edge. These shingles may be 3 or more layers thick in some places, dulling traditional knives and saws quickly.

Traditionally, a knife has been used for such cuts. However, there is little precision in depth of cut with a knife, and in addition, such a cut can be laborious and difficult. Too deep a cut may create roof leaks. Power saws and the like are difficult to use as the saw may require an extension cord on the roof and also the blade may not be well suited for cutting shingles (i.e., it will “load up” with tar and other materials and cease to cut well). In addition, large power tools present a hazard to workers below if they fall off the roof. What is needed is a small powered tool, which can cut shingles accurately and cleanly.

Parent application Ser. No. 10/691,967, filed on Oct. 24, 2003, incorporated herein by reference, discloses a SHINGLESAW™ using an air motor directly coupled to a saw blade through a right angle drive. While this model of the SHINGLESAW™ has seen market success, the drive design does have some limitations. In particular, a high speed air motor, such as used for a die grinder, is capable of generating high RPMs, but is not capable of generating a lot of torque. As such, it can be relatively easy to stall such an air motor, as any user of a die grinder is well aware.

In an application such as roofing, oftentimes, small “pancake” compressors are used which have limited capacity in terms of flow rate (CFM). For traditional roofing tools, such as nail guns and the like, high pressure but lower flow rates are acceptable, as a nail gun does not require large quantities (e.g., high CFM) of air in order to operate. Direct drive or high-speed air motors such as die grinders, rotary sanders, drills, or the like often require a fairly high flow rate of air if they are to operate properly. Thus, in a roofing application, a direct drive design may have limited torque. In addition, while a die grinder or the like may have a relatively small grinding head, the SHINGLESAW™ has a fairly large (3-4″) diameter saw blade, which may require more torque to operate. Moreover, rotary saw blades, in general operate better at slower speeds than those used by traditional air tools.

Shearon et al., U.S. Pat. No. 4,685,214, issued Aug. 11, 1987 and incorporated herein by reference, discloses a Protective Guard Unit for a Metal Working Tool. Shearon discloses a an air-powered saw using a conventional air motor and a right angle gearbox (See, Shearon, FIG. 2, elements 22 and 24) to change the direction of rotary motion of the air motor shaft by 90 degrees. The Shearon design suffers from the same limitation as the SHINGLESAW™ of FIGS. 1 and 2 in that the torque limitations of a “conventional” air motor may cause the blade to stall when cutting through heavy materials, such as shingles. Shearon, however, is directed toward metal working, which is typically performed in a metalworking shop and not in situ. As such, a metal worker is more likely to have access to a high pressure and high flow rate air supply which may mitigate some of the torque issues in such a design.

What remains a requirement in the art, therefore, is an air-powered saw which can provide high torque while using compressed air from a relatively low flow-rate air supply such as a roofer's pancake-style compressor or the like.

### SUMMARY OF THE INVENTION

The SHINGLESAW™ of the present invention comprises a pneumatically powered miniaturized circular saw designed especially for roofing applications. An airmotor is used to drive a planetary gear set to reduce output shafts RPM to speeds more favorable to rotary saw blades. By reducing RPM, the planetary gear set also increases shaft torque, which reduces the likelihood of stalling the blade when cutting through heavy and sticky roofing shingles.

### BRIEF DESCRIPTION OF THE DRAWINGS

FIG. 1 is a front perspective view of the SHINGLESAW™ of the parent application.

FIG. 2 is a rear perspective view of the SHINGLESAW™ of the parent application.

FIG. 3 is a side view of a blade design for the SHINGLESAW™ of the present invention.

FIG. 4 is a side view of a second blade design for the SHINGLESAW™ of the present invention.

FIG. 5 is a side view of a third blade design for the SHINGLESAW™ of the present invention.

FIG. 6 is a side view of another embodiment of a saw blade for the rotary version of the SHINGLESAW™ of the present invention.

FIG. 7 is a side view of another embodiment of a saw blade for the rotary version of the SHINGLESAW™ of the present invention.

FIG. 8 is a side view of another embodiment of a saw blade for the rotary version of the SHINGLESAW™ of the present invention.

FIG. 9 is a side view of another embodiment of a saw blade for the rotary version of the SHINGLESAW™ of the present invention.

FIG. 10 is a side view of another embodiment of a saw blade for the rotary version of the SHINGLESAW™ of the present invention.

FIG. 11 is an exploded view of the air motor and planetary gear reduction set of the present invention, illustrating how the planetary gear set is integrated into the air motor.

FIG. 12 is an enlarged perspective view of a saw blade tooth design for the SHINGLESAW™ of the present invention.

FIG. 13 is a front perspective view of the SHINGLESAW™ of the present invention.

FIG. 14 is a rear perspective view of the SHINGLESAW™ of the present invention.

### DETAILED DESCRIPTION OF THE INVENTION

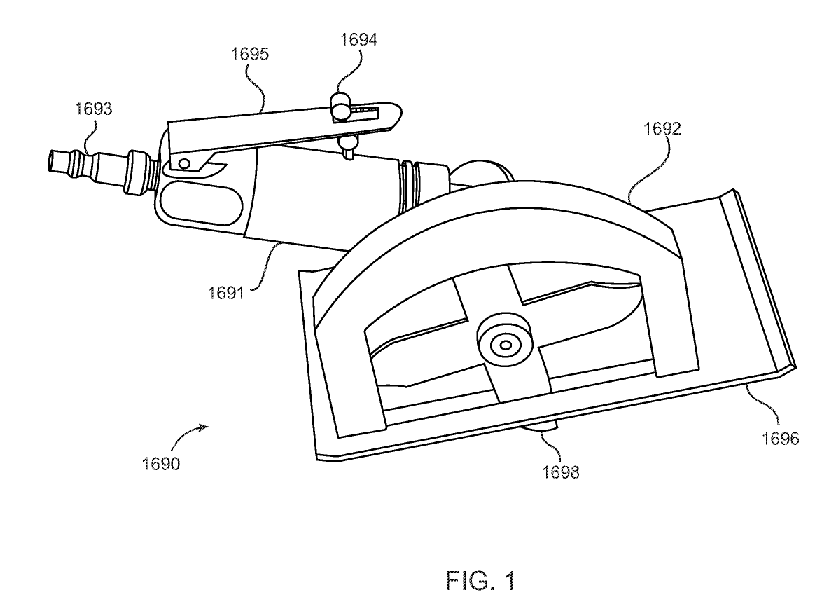

FIG. 1 is a front perspective view of one embodiment of the SHINGLESAW™ as illustrated in the parent application. FIG. 2 is a rear perspective view of f the SHINGLESAW™ of the parent application. This embodiment of SHINGLESAW™ illustrates the first production model to be marketed by the assignee of the present invention. A Prior Art angle grinder airmotor 1691 is provided with a saw housing assembly 1692 formed of anodized aluminum, clamped to the output portion of the airmotor via clamp 1650. The housing assembly 1692 may be coated with Teflon to reduce buildup of tar and other roofing material cutting detritus

The airmotor may be provided with a quick connect 1693 to allow it to be connected to an air line such as used by a roofer for a nail gun or the like. A safety 1694 may be provided to the lever switch 1695 to prevent a user from accidentally activating the SHINGLESAW™ 1690. The blade housing and guard 1692 may be pivotally mounted to the shoe plate 1696 by means of an adjustable wing nut 1697 so as to allow for depth control of the cut. Note the four bladed saw 1698 in FIG. 4, with each blade provided with a carbide tip (not shown).

SHINGLESAW™ unlike Prior Art circular saws and the like, is small enough to fit in roof valleys and other tight areas where larger saws will not fit. Unlike rechargeable battery-powered saws, the SHINGLESAW™ in the embodiment of FIG. 4, uses air power, and thus has the power and capacity for extended work.

SINGLESAW™ may also be provided with a cutting guide attached to the underside of shoe plate 1696, behind blade 1698 to act as a cutting guide in a similar manner to a rip fence on a circular saw, but to make flush cuts such as on the edge of a roof, such that the saw blade will cut flush with the drip edge without the saw blade cutting the drip edge itself.

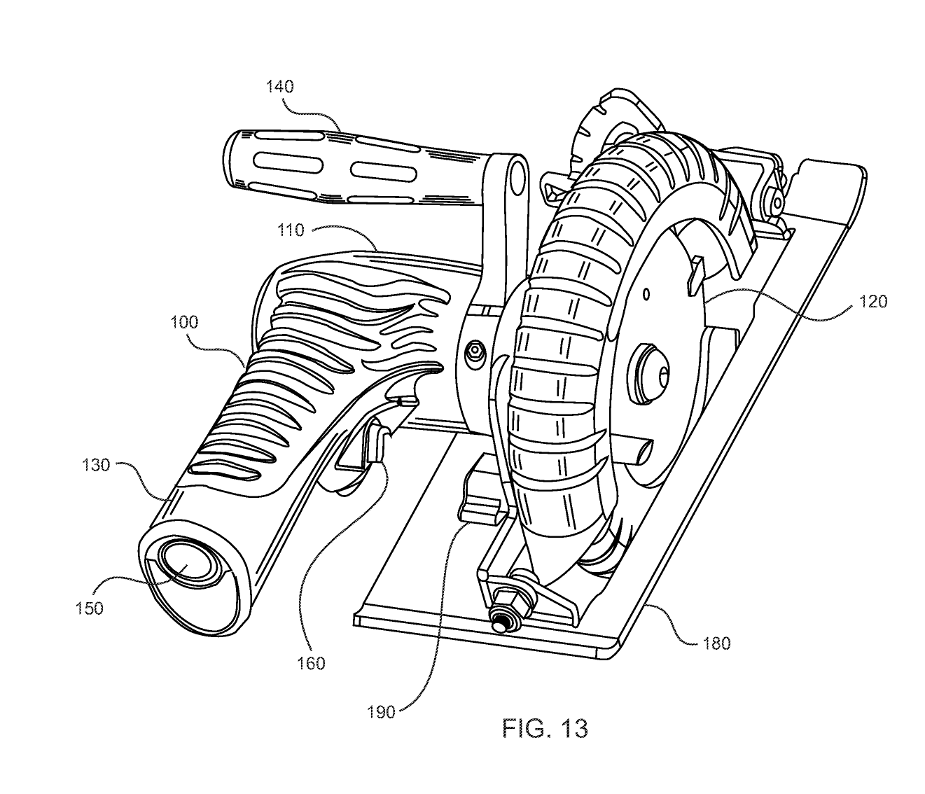

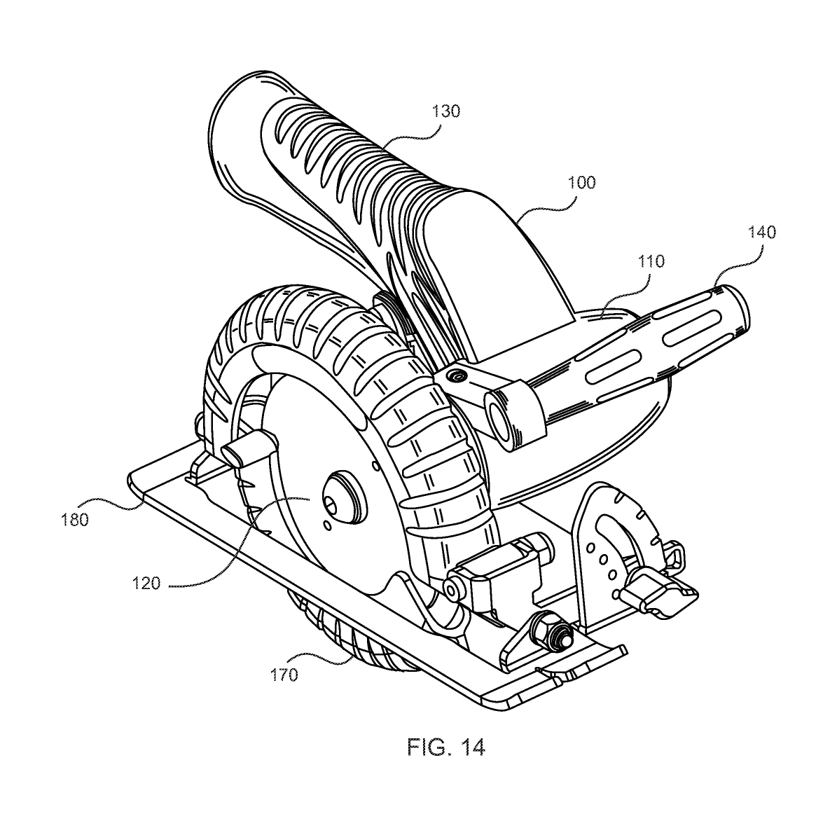

FIGS. 13 and 14 illustrate front and rear perspective views of the SHINGLESAW™ of the present invention. This embodiment has been productized for mass production and may be include a housing 100 injection molded from plastic components. The air motor and transmission 110 may be provided with housing 100, having a drive shaft running in the same axis as saw blade 120. Unlike the design of FIGS. 1 and 2, a 90-degree drive is not required to change the direction of rotary motion of the air motor. Handle 130 may be used to grip the saw and also provide a path for an air input 150 and a location for on/off valve 160.

Note that the location of the air motor and transmission 110 in this design is more akin to that of a traditional circular saw, in that the motor is in a direct line with the blade shaft. This arrangement allows for better weight distribution of the apparatus, such that the weight of the motor is not placed within handle 130 as in the design of FIGS. 1 and 2. Moreover, this design eliminates the 90-degree drive used in the embodiment of FIGS. 1 and 2 and by the Shearon et al. Patent. The use of injection-molded plastic housing and components reduces the overall cost of the apparatus, making it affordable to roofers and even homeowners and other users.

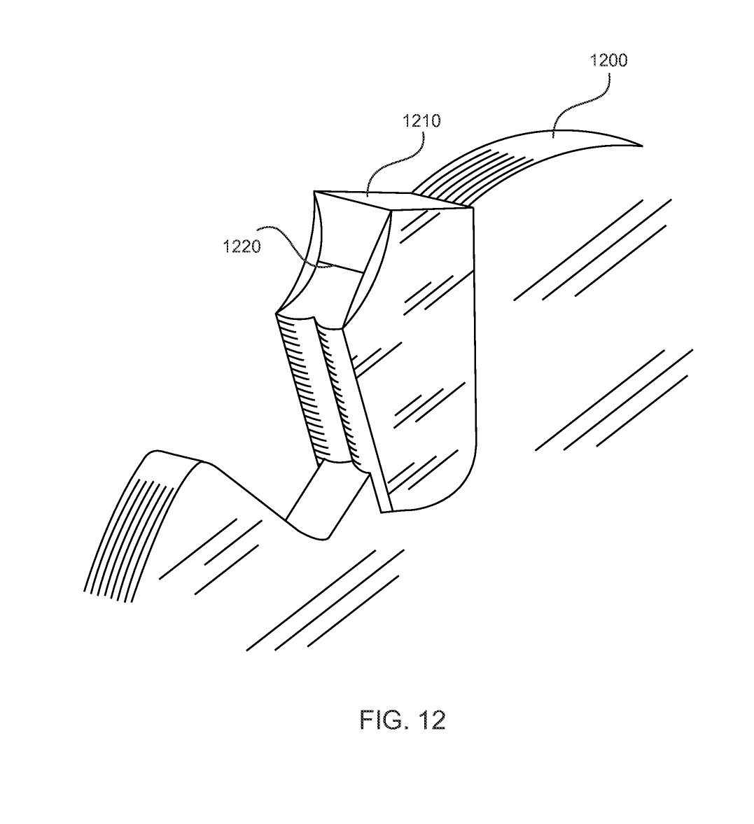

FIG. 11 is an exploded view of the air motor and transmission 110 of FIGS. 13 and 14. Referring to FIG. 11, barrel 1 is the main housing of the air motor and transmission 110 which may be housed within housing 100 of FIGS. 12 and 13. Within barrel 1, rotor 2 may be provided, which is provided with vanes 9, which preferably may comprise four vanes as illustrated in the drawing. Air entering into cage 6 acts upon vanes 9 and causes rotor 2 to rotate. Front and rear plates 7 and 8, respectively, enclose the ends of cage 5, while bearings 5 support the shaft ends of rotor 2. Bearings 5 may rest in bearing carriers 4 which in turn may be attached to barrel 1. The aforementioned components of FIG. 11 form the motor portion of the air motor and transmission 110.

An optional spacer 10 may be used to space the air motor portion from gear carrier 11. Gear carrier 11 supports the transmission portion of air motor and transmission 110 within barrel 1. The transmission includes gear cage 17 which may be provided with a number of planetary pinion gears 16 (e.g. four) which rotate on pin 15 attached to gear cage 17. Gear cage 17 may rotate on bearings 12. Drive gear 14 may be used to drive planetary pinion gears 16. Drive washers 13 may be used to properly center gear carrier 11. Ring gear 18 may be mounted to barrel 1. In operation, rotary output from the motor portion may be fed to drive gear 14, which turns pinion gears 16 within gear cage 17. Pinion gears 16 engage ring gear 18, which is stationary (mounted to the inside of barrel 1) causing gear cage 17 to rotate. The output side of gear cage 17 is coupled to arbor 3 which may be used to mount a saw blade.

The planetary gear set illustrated in FIG. 11 is inexpensive and easy to fabricate and requires little room to implement, resulting in a compact design. In addition, the planetary gear set does not require a change in the direction of travel of the rotary motion, and thus the input and output shafts are coaxial.

SHINGLESAW™ may be sized to fit in one hand, much as a prior art razor knife is designed to fit. Adjustable depth gauge 1900 may be adjusted via wing nut to control depth of cut and prevent blade 120 from piercing underlayment or the like. A safety guard 170, similar to that of a circular saw, only suitably miniaturized, may be provided to protect the user. An air chuck allows SHINGLESAW™ to be connected to an air line (such as used for roofing nail guns or the like). Lever 160 may activate an air switch to activate the pneumatic actuator of SHINGLESAW™.

SHINGLESAW™ unlike Prior Art circular saws, is small enough to fit in roof valleys and other tight areas where larger saws will not fit. Unlike rechargeable battery-powered saws, the SHINGLESAW™ uses air power, and thus has the power and capacity for extended work.

SINGLESAW™ may also be provided with a cutting guide (not shown) attached to the underside of shoe plate 180, behind blade 120 to act as a cutting guide in a similar manner to a rip fence on a circular saw, but to make flush cuts such as on the edge of a roof, such that the saw blade will cut flush with the drip edge without the saw blade cutting the drip edge itself.

The SHINGLESAW™ of the present invention may be provided with a rotary double-edged cutting blade of approximately 2″ in length. Other numbers of edges may also be used (e.g., four edges). In another embodiment, removable carbide blade inserts may be provided on blade element. Such carbide blade inserts may be held in place by set-screw, clip, or the like. Carbide provides the necessary hardness to withstand the abrasive environment of shingle-cutting, as the asphalt and abrasive grit of shingles may wear down a regular steel blade rapidly.

Various blade types may be used with the gear-reduction SHINGLESAW™ of the present invention. The following Figures illustrate examples of blade designs for use with the present invention.

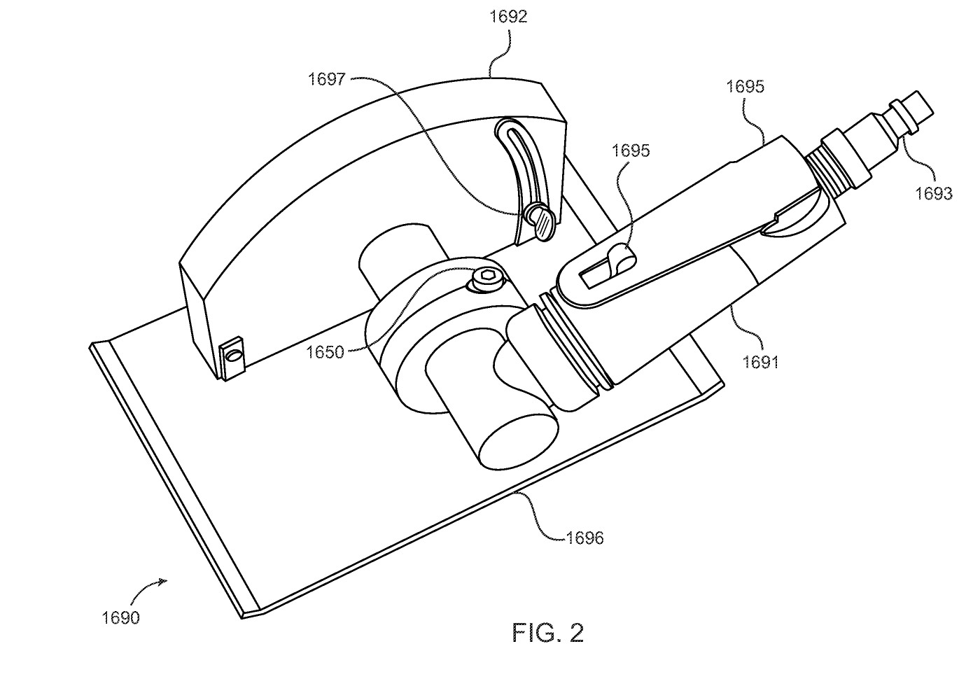

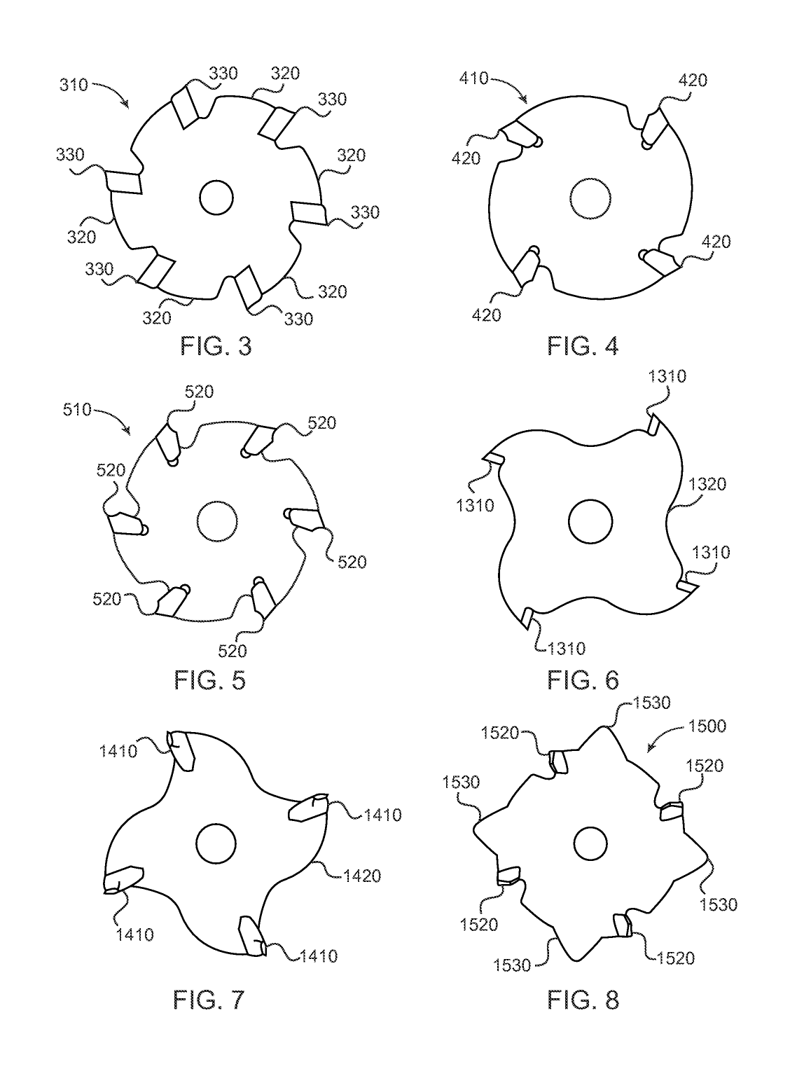

FIG. 3 is a side view of a blade design 310 for the SHINGLESAW™ of the present invention. In this design, six blade tips 320 are provided, each with a carbide insert 330. The shape of the blade is designed to prevent the blade from “loading up” with roofing tar and debris. The blade in the preferred embodiment is 3⅜″ in diameter, but may also be made in 4″, 6″ and even standard circular saw sizes (e.g., 7.22″ or the like). However, in the preferred embodiment the saw blade is made smaller to keep the overall tool size compact and also to allow the low-torque air motor sufficient leverage to cut the shingles.

FIG. 4 is a side view of a second blade design 410 for the SHINGLESAW™ of the present invention. FIG. 5 is a side view of a third blade 510 design for the SHINGLESAW™ of the present invention. In these designs, which may have the same diameters as the saw blade discussed above in connection with FIG. 3, are provided with a “chipper” design carbide inserts 420 and 520. FIG. 12 is an enlarged perspective view of a saw blade 1200 tooth design 1210 for the SHINGLESAW™ of the present invention illustrating this chipper design 1210. Tooth 1210 is provided with a concave portion 1220 which may be inclined with respect to the direction of rotation of the saw, as illustrated in FIG. 12. By inclining the tooth face, the tooth 1210 may be less likely to accumulate material, such a sticky roofing material, and thus clog and jam. The concave surface 1220 provides a sharper edge for better cutting and also helps reduce buildup. This chipper design saw blade tooth helps prevent buildup of tar and other roofing debris on the saw blade.

Different blade and blade teeth designs may be employed to cut different types of materials such as wood, metal, or the like. While disclosed in the preferred embodiment as cutting shingle materials, the SHINGLESAW™ may be used to cut other materials. Unlike Prior Art circular saw blades, which are designed to make thin cuts, the SHINGLESAW™ blade is approximately ¼″ thick to make a wide cut without binding in the cut material. Experiments with Prior Art circular saw blades shows these blades to bind when cutting through several layers of roofing material.

FIG. 6 is a side view of another embodiment of a saw blade for the rotary version of the SHINGLESAW™ of the present invention. This blade is designed to cut shingles including fiber cement shingles, without binding or loading up. Blade 1320 may be provided in any one of a number of sizes, including the smaller sizes discussed above for use with the SHINGLESAW™ of the present invention, and also provided in larger sizes for use with standard circular saws.

To prevent binding, blade 1320 may be Teflon™ coated or coated with another type of non-stick material. Blade 1320 is shaped with a dropoff behind each blade tip element 1310 to prevent loading with roofing material or the like. As most roof shingles contain tar and tar-like elements, when cutting such shingles, tar and cutting debris tends to cling to the blade and cause clogging or binding. By providing a pronounced dropoff behind each blade tip element 1310, such binding and loading is reduced. Blade tip element 1310 may comprise a carbide bit as discussed above, and may include any one of the carbide bit designs disclosed herein or known in the art.

FIG. 7 is a side view of another embodiment of a saw blade for the rotary version of the SHINGLESAW™ of the present invention. In this embodiment, blade 1410 is provided with an even sharper dropoff from the blade tip element 1410 to reduce clogging and the like. Note that blade tip element 1410 is illustrated with a blade tip design similar to or identical to that in FIG. 12.

FIG. 8 is a side view of another embodiment of a saw blade for the rotary version of the SHINGLESAW™ of the present invention. In this embodiment, blade 1510 is provided with cut cleaning elements 1530 to remove debris and the like from the cut slot when the saw blade is cutting. Note that in this illustration, the blade should appear symmetrical, and moreover, cut cleaning elements 1530 are provided at a radius less than or equal to the radius of blade tips 1520, such that they ride in the cut groove at a depth slightly less than blade tips 1520. When cutting shingles, tar and shingle debris tends to clog the cutting slot, causing binding and uneven cutting. This blade design helps reduce this problem by ejecting cut material from the cut slot, allowing for more even cutting and less binding.

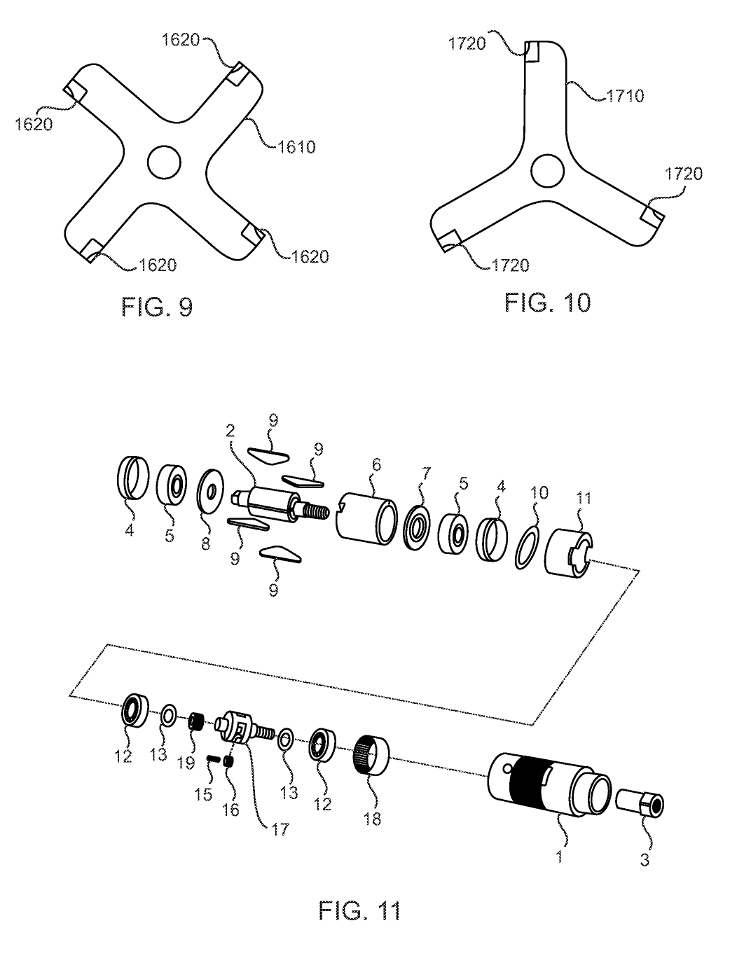

FIG. 9 is a side view of another embodiment of a saw blade for the rotary version of the SHINGLESAW™ of the present invention. In this embodiment, a four-bladed blade 1610 design is used with carbide tips 1620. The use of the four thin blades helps prevent buildup of tar and the like and also allows for ejection of material. Again, carbide tips 1620 according to any of the designs illustrated herein or known in the art may be applied.

FIG. 10 is a side view of another embodiment of a saw blade for the rotary version of the SHINGLESAW™ of the present invention. Similar to FIG. 9, this design uses three thin blades 1710, and may be more useful at higher RPMs than the four-bladed design of FIG. 9. Carbide tips 1720 may comprise any of the carbide tips designs illustrated herein or known in the art.

While the preferred embodiment and various alternative embodiments of the invention have been disclosed and described in detail herein, it may be apparent to those skilled in the art that various changes in form and detail may be made therein without departing from the spirit and scope thereof.

1. An air powered circular saw comprising:
an air motor, for receiving compressed air and driving a rotary shaft;
a planetary gear transmission, attached to the rotary shaft, for reducing rotational speed of the rotary shaft to a lower speed at an output shaft coaxial with the rotary shaft;
an air motor and transmission housing, for housing both the air motor and the planetary gear transmission;
a saw housing, housing the air motor and transmission housing and having a handle portion at a substantially right angle to the air motor and transmission housing, the handle portion including an air inlet for receiving compressed air for the air motor and a control lever for controlling flow of compressed air to the air motor;
a rotary sawblade, coupled to the output shaft of the planetary gear transmission and perpendicular to the axis of the output shaft of the planetary gear transmission;
a shoe plate, adjustably coupled to the saw housing, for controlling a depth of cut of the sawblade;

2. The air powered circular saw of claim 1, wherein the sawblade comprises a carbide-tipped sawblade having a chipper edged carbide bit.

3. The air powered circular saw of claim 2, wherein the chipper edged carbide bit has a face inclined against the direction of rotation of the blade.

4. The air powered circular saw of claim 1, wherein the chipper edged carbide bit has a concave face.

5. The air powered circular saw of claim 1, wherein the blade comprises a rotary saw blade of 3⅜″ to 5″ in diameter having 4 to 8 teeth, each of the 4 to 8 teeth having a carbide bit.

6. The air powered circular saw of claim 5, wherein the air motor further includes an on-off valve, the on-off valve provided with a safety latch to prevent the on-off valve from being actuated unless the safety latch is first released.

7. The air powered circular saw of claim 1, wherein the sawblade comprises a four-bladed blade having carbide tips on each blade.

8. The air powered circular saw of claim 1, wherein the sawblade comprises a six-bladed blade having carbide tips on each blade.

9. The air powered circular saw of claim 1, wherein the sawblade is approximately ¼″ thick so as to provide a wide cut without binding.

10. The air powered circular saw of claim 1, wherein the sawblade is substantially 3⅜″ in diameter so as to cut through multiple layers of shingles without binding.
